(19) United States
(12) Patent Application Publication
(10) Pub. No.: US 2024/0422866 A1
(43) Pub. Date: Dec. 19, 2024

(54) LIQUID HEATING DEVICE

(71) Applicant: NITERRA CO., LTD., Nagoya-shi, Aichi (JP)

(72) Inventors: Yusuke MAKINO, Nagoya-shi, Aichi (JP); Yuya HIGASHIDE, Nagoya-shi, Aichi (JP)

(73) Assignee: NITERRA CO., LTD., Nagoya-shi, Aichi (JP)

(21) Appl. No.: 18/703,807

(22) PCT Filed: Nov. 18, 2022
(86) PCT No.: PCT/JP2022/042819

§ 371 Date: Apr. 23, 2024

(30) Foreign Application Priority Data
Dec. 20, 2021 (JP) 2021-205825

(51) Int. Cl. H05B 3/82; H05B 3/14; H05B 3/46

(52) U.S. Cl. CPC H05B 3/82; H05B 3/14; H05B 3/46

(57) ABSTRACT

A liquid heating device 200 comprising: a container 100 having an internal space 100i, and an inlet 103 and an outlet 105 communicating with the internal space; and a ceramic heater 171-172 which extends in a front-rear direction L and whose front-end portion 17T is located in the internal space, the ceramic heater having a heat generation portion 17a at the distal-end portion, wherein in a process in which a liquid W is introduced from the inlet and flows through the internal space to the outlet, the liquid is heated by the ceramic heater, the ceramic heater has an inner hole 17i extending in the front-rear direction and having an opening m at a distal end, the inner hole communicating with the internal space, and the inner hole is closed by a closing portion 60 on a base-end side.

### TECHNICAL FIELD

The present invention relates to a liquid heating device which heats a liquid such as water by a ceramic heater.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used.

In particular, for the purpose of rapid heating for warm water of a warm water washing toilet seat, etc., or achieving downsizing of the liquid heating device, a rod-shaped ceramic heater having a heat generation portion embedded in a ceramic sheet wrapped around the outer circumference of an elongated ceramic base is used (Patent Document 1).

### PRIOR ART DOCUMENT

### Patent Document

Patent Document 1: Japanese Patent Application Laid-Open (kokai) No. H09-289073

### SUMMARY OF THE INVENTION

### Problem to be Solved by the Invention

In general, a rod-shaped ceramic heater has a through hole at the center. A liquid heating unit described in Patent Document 1 has such a structure that a base-end portion of the ceramic heater is retained at a side surface of a case for storing a liquid and a distal-end side of the ceramic sheet contacts with the liquid in the case.

Then, in order to prevent the liquid from leaking out of the case from the through hole of the ceramic heater, a distal end of the through hole is sealed by a ceramic plate.

Meanwhile, size reduction in the liquid heating device is required, and the size of the ceramic heater also tends to be reduced. However, if the size of the ceramic heater is reduced (the diameter is reduced), it is necessary to more increase the heating temperature of the heater when producing warm water having a desired temperature, so that the heater might suffer crack, breakage, or the like.

In addition, due to overheating of the heater, a fixation part (sealing part) between the heater and the liquid heating device might be damaged, leading to leakage of the liquid.

Accordingly, an object of the present invention is to provide such a liquid heating device that leakage of a liquid from an inner hole of a ceramic heater to outside is prevented and damage or the like of the ceramic heater due to overheating is prevented.

### Means for Solving the Problem

In order to solve the above problem, a liquid heating device of the present invention is a liquid heating device comprising: a container having an internal space, and an inlet and an outlet communicating with the internal space; and a ceramic heater which extends in a front-rear direction and whose front-end portion is located in the internal space, the ceramic heater having a heat generation portion at the distal-end portion, wherein in a process in which a liquid is introduced from the inlet and flows through the internal space to the outlet, the liquid is heated by the ceramic heater, the ceramic heater has an inner hole extending in the front-rear direction and having an opening at a distal end, the inner hole communicating with the internal space, and the inner hole is closed by a closing portion on a base-end side.

With this liquid heating device, in the structure in which the ceramic heater has the inner hole and the inner hole communicates with the internal space of the container, the inner hole is closed on the base-end side, whereby the liquid in the container can be prevented from leaking from the inner hole to outside.

Further, since the distal-end side of the inner hole is opened as an opening, the air in the inner hole expands and contracts through heating of the heater and stop of the heating, and the liquid can be easily introduced into the inner hole when the air contracts. Thus, the ceramic heater is cooled via the inner hole, whereby damage or the like due to overheating of the ceramic heater can be prevented.

In the liquid heating device of the present invention, the closing portion may be located on a base-end side relative to the heat generation portion.

With this liquid heating device, as compared to a case where the closing portion is located on the distal-end side relative to the heat generation portion, the volume of the inner hole can be increased, so that the amount of the liquid introduced into the inner hole through expansion and contraction of the air in the inner hole described above can be increased.

In the liquid heating device of the present invention, the closing portion may be provided to a member separate from the ceramic heater, the separate member being connected to a base end of the ceramic heater so that, inside the separate member, a second internal space may be formed as a part of the inner hole.

With this liquid heating device, the inner hole of the ceramic heater and the second internal space of the separate member communicate with each other, so that the volume of the inner hole of the ceramic heater substantially increases by an amount corresponding to the second internal space of the separate member.

Then, expansion and contraction of the air in the inner hole become greater as compared to the case of not using a separate member. Thus, the amount of the liquid introduced into the inner hole through expansion and contraction of the air in the inner hole can be increased, whereby cooling of the ceramic heater via the inner hole can be further promoted.

In the liquid heating device of the present invention, a watt density may be 100 W/cm² when AC voltage of 100 V is applied to the ceramic heater.

If the watt density is 100 W/cm², the heating temperature of the heater readily becomes a higher temperature. Therefore, the present invention can be effectively applied.

In the liquid heating device of the present invention, in a cross-section of the ceramic heater along a radial direction perpendicular to the front-rear direction, a maximum width of an inner wall surface forming the inner hole may be 0.5 to 5.0 mm.

if the maximum width of an inner wall surface forming the inner hole is 0.5 to 5.0 mm, the liquid hardly enters the inner hole. Therefore, the present invention is effectively applied.

### Advantageous Effects of the Invention

The present invention makes it possible to provide such a liquid heating device that leakage of a liquid from an inner hole of a ceramic heater to outside is prevented and damage or the like of the ceramic heater due to overheating is prevented.

### BRIEF DESCRIPTION OF THE DRAWINGS

FIG. 1 Perspective view showing the outer appearance of a liquid heating device according to an embodiment of the present invention.

FIG. 2 Perspective view showing the outer appearance of a ceramic heater.

FIG. 3 Exploded perspective view showing the configuration of the ceramic heater.

FIG. 4 See-through view along line A-A in FIG. 1.

FIG. 5 Schematic view illustrating an effect owing to a structure in which an inner hole of the ceramic heater is closed on the base-end side and is opened as an opening on the distal-end side.

FIG. 6 Sectional view showing another example of a closing portion.

FIG. 7 Diagram showing a method for measuring the maximum width of an inner wall surface forming the inner hole of the ceramic heater.

### MODES FOR CARRYING OUT THE INVENTION

Hereinafter, an embodiment of the present invention will be described.

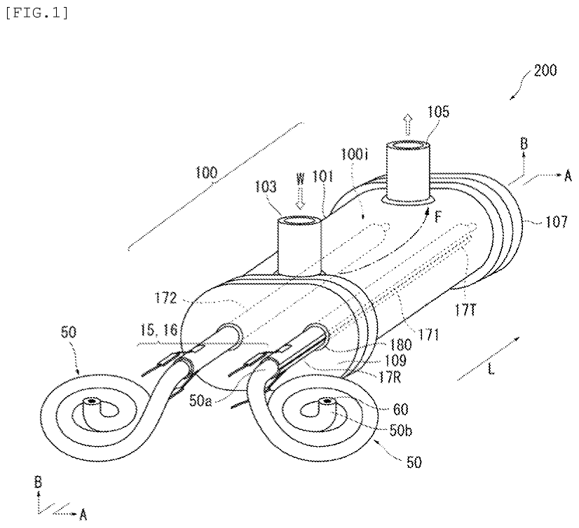

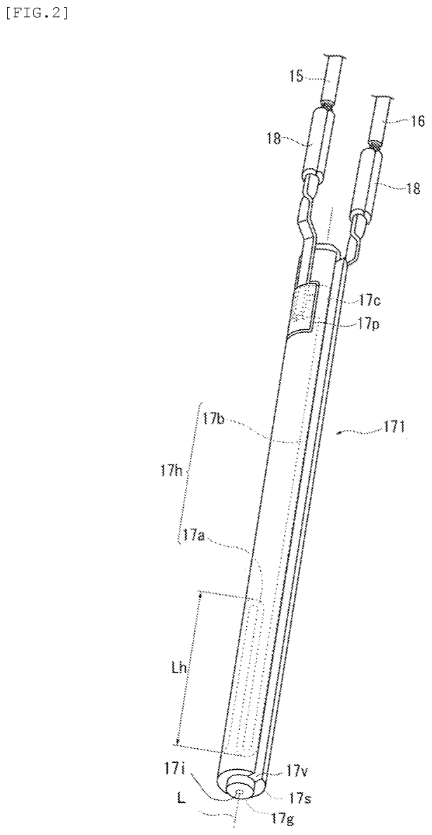

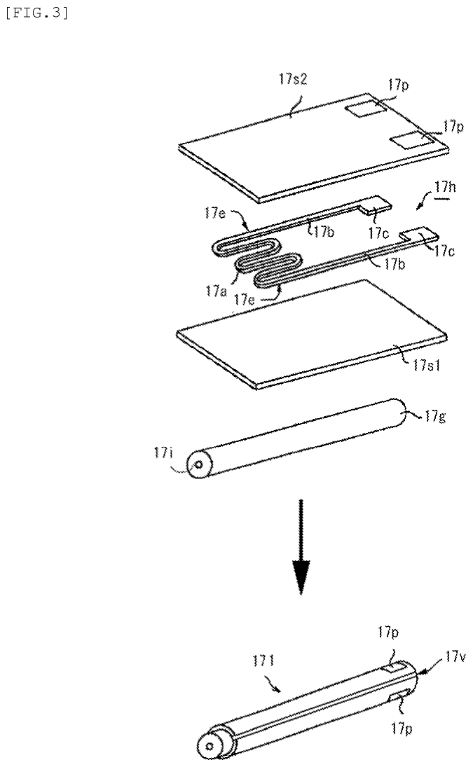

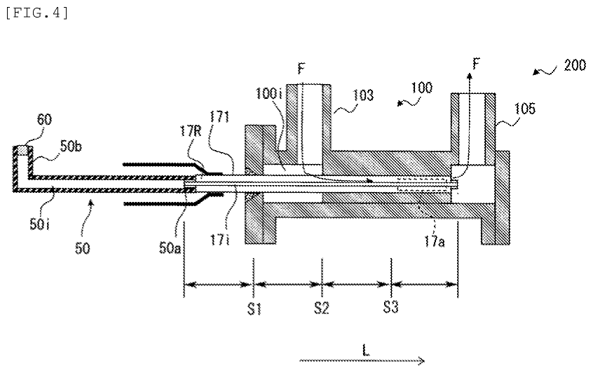

FIG. 1 is a perspective view of a liquid heating device 200 according to the embodiment of the present invention. FIG. 2 is a perspective view of a ceramic heater 171. FIG. 3 is an exploded perspective view of the ceramic heater 171. FIG. 4 is a see-through view along line A-A in FIG. 1.

In this embodiment, the liquid heating device 200 is provided to a warm water washing toilet seat, and heats ordinary-temperature water by two built-in ceramic heaters 171, 172, to supply warm water.

The liquid heating device 200 has substantially an oblong tubular shape (a tubular shape whose cross-section is a rectangle with rounded corners) in its entirety, and has a container 100 and the two ceramic heaters 171, 172.

The container 100 has an oblong tubular trunk portion 101 having an internal space 100i for storing a liquid W (water), a front-end lid 107 and a rear-end lid 109 that close openings at both ends in the axial direction of the trunk portion 101, and an inlet 103 and the outlet 105 for the liquid W which are provided integrally with the trunk portion 101.

Both ends in the axial direction of the trunk portion 101 protrude in a flange shape in the radial direction. Both ends of the trunk portion 101, and the front-end lid 107 and the rear-end lid 109, are respectively sealed with each other in an airtight state by O rings 190 (not shown).

The ceramic heaters 171, 172 have rod shapes extending in a front-rear direction L, and are arranged side by side toward the same direction (in parallel). A base-end portion 17R of each ceramic heater 171, 172 is retained in a cantilever manner by a sealing portion 180 at an opening of the rear-end lid 109 of the container 100, whereby each ceramic heater 171, 172 is attached to the container 100. A front-end portion 17T of each ceramic heater 171, 172 is located in the internal space 100i. Needless to say, the retained part by the sealing portion 180 is on the base-end side relative to the heat generation portion 17a of the ceramic heater described later.

Lead wires 15, 16 described later for supplying power from outside are connected to the base-end portion 17R sides of the ceramic heaters 171, 172.

In this example, one end 50a of a tubular rubber hose 50 described later in detail is connected to the base end of each of the ceramic heaters 171, 172. The rubber hose 50 is wound along the horizontal direction, and an inner hole at another end 50b protruding upward from the center of the wound part is sealed by resin 60.

The resin 60 corresponds to a “closing portion” in the claims.

In this example, the axial direction of the trunk portion 101 is parallel to the front-rear direction L, and the ceramic heaters 171, 172 are stored in the internal space 100i of the trunk portion 101 such that the direction in which the ceramic heaters 171, 172 are arranged side by side is along the major axis of the cross-section of the trunk portion 101.

Although not shown, in this example, the liquid heating device 200 is provided to the warm water washing toilet seat such that the front-rear direction L is substantially the horizontal direction and the outlet 105 side is located slightly upward, and the ceramic heaters 171, 172 are laid horizontally.

The inlet 103 and the outlet 105 communicate with the internal space 100i and are located apart from each other in the front-rear direction L (also corresponding to the axial direction of the trunk portion 101). The liquid W introduced through the inlet 103 from outside passes through the internal space 100i along a flow direction F and then is discharged from the outlet 105.

A gap is formed between the inner wall of the container 100 and each ceramic heater 171, 172. The liquid W introduced into the internal space 100i through the inlet 103 contacts with the outer surfaces of the ceramic heaters 171, 172 along the front-rear direction L, thus being heated, and then the liquid W flows to the outlet 105.

Next, with reference to FIG. 2 and FIG. 3, the configuration of the ceramic heater will be described. The ceramic heaters 171, 172 have the same shape and therefore the ceramic heater 171 will be described.

As shown in FIG. 2, the ceramic heater 171 has a heat generation body 17h which generates heat by being energized from outside via the lead wires 15, 16. The heat generation body 17h has, on the front-end side, the heat generation portion 17a formed by meandering a conductor in the front-rear direction L as a heat generation pattern, and has a pair of lead portions 17b led from both ends of the heat generation portion 17a to the rear-end side.

The heat generation portion 17a is formed over a region Lh in the front-rear direction L.

More specifically, as shown in FIG. 3, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which lead terminals 18 (see FIG. 2) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The ceramic base 17g has a tubular shape. An inner hole 17i, which is a through hole, is provided at the center of the ceramic base 17g.

The lead wires 15, 16 are crimped with the lead terminals 18 so as to be electrically connected thereto (see FIG. 2).

Here, in wrapping the laminated body around the ceramic base 17g, the laminated body is wrapped such that both ends along the front-rear direction L of the laminated body are spaced from each other. Thus, at a wrap-meeting part on the outer surface of the ceramic heater 171, a slit 17v forming a recessed groove along the front-rear direction L is formed as a non-heat generation portion.

Therefore, as seen in the cross-section of the ceramic heater 171 along the radial direction, the heat generation portion 17a is embedded in the ceramic heater 171 so as to form a ring shape having ends, and the slit 17v as a non-heat generation portion is formed between two ring ends 17e of the heat generation portion 17a.

Alternatively, without the ceramic green sheet 17s1, the heat generation body 17h may be formed by printing or the like on the back-surface side of the ceramic green sheet 17s2, and the ceramic green sheet 17s2 may be wrapped, with the heat generation body 17h side facing the ceramic base 17g. In this case, the heat generation body 17h (heat generation portion 17a) is placed between the ceramic base 17g and the ceramic green sheet 17s2.

Next, with reference to FIG. 4, features of the liquid heating device 200 will be described.

As shown in FIG. 4, the inner hole 17i of the ceramic heater 171 has an opening at a distal end and communicates with the internal space 100i of the container 100.

Meanwhile, on the base-end side of the ceramic heater 171, the one end 50a of the rubber hose 50 is connected so as to be externally fitted to the ceramic base 17g. Inside the rubber hose 50, a second internal space 50i is formed as an inner hole so as to communicate with the inner hole 17i and become a part of the inner hole 17i.

The inner hole at the other end 50b of the rubber hose 50 is sealed by the resin 60.

As described above, the other end 50b of the rubber hose 50 communicating with the inner hole 17i is closed by the resin 60, whereby the base-end side of the inner hole 17i is also closed.

Thus, in the structure in which the ceramic heater 171 has the inner hole 17i and the inner hole 17i communicates with the internal space 100i of the container 100, the inner hole 17i is closed on the base-end side, whereby the liquid W in the container 100 can be prevented from leaking from the inner hole 17i to outside.

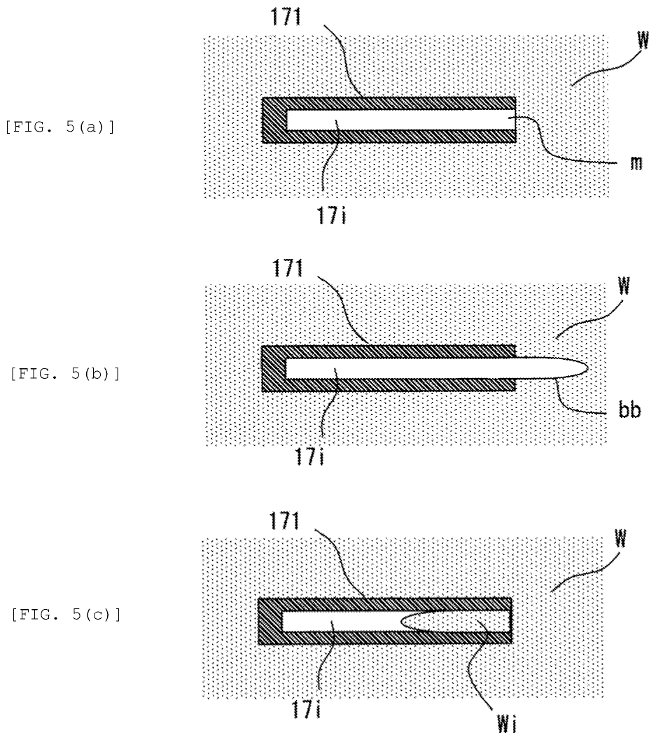

Further, since only the distal-end side of the inner hole 17i is opened as the opening, damage or the like due to overheating of the ceramic heater 171 can be prevented. This effect will be described with reference to FIG. 5.

First, when the liquid W is initially introduced into the container 100, the liquid W enters a part (distal-end side) of the inner hole 17i from an opening m on the distal-end side of the inner hole 17i, or if the inner hole 17i has a small diameter, the liquid W does not enter the inner hole 17i and the air stays inside the inner hole 17i (FIG. 5(a)).

Next, when the ceramic heater 171 is heated, the air or the liquid W present in the inner hole 17i expands or boils to become a bubble bb, but since the base-end side of the inner hole 17i is closed, the bubble bb is discharged through the opening m to the container 100, so that the heated air stays in the inner hole 17i (FIG. 5(b)).

Thereafter, when heating of the ceramic heater 171 is stopped, the air inside the inner hole 17i is cooled and contracted, so that the liquid W in the container 100 enters the inner hole 17i from the opening m, as entry water Wi, thereby cooling the ceramic heater 171 from the inner hole 17i side (FIG. 5(c)).

Thus, damage or the like due to overheating of the ceramic heater 171 is prevented.

In particular, if the size of the ceramic heater is reduced (the diameter is reduced), it is difficult to introduce the liquid W into the inner hole 17i, but by utilizing expansion and contraction of the air in the inner hole 17i as described above, the liquid W can be easily introduced into the inner hole 17i, to perform cooling.

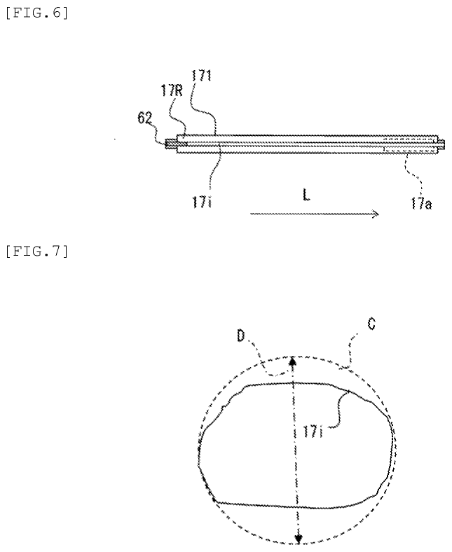

Here, for example, as shown in FIG. 6, the base-end side of the inner hole 17i of the ceramic heater 171 (ceramic base 17g) may be directly closed by a closing portion 62 such as a seal material. However, making closing by using a member (rubber hose 50) separate from the ceramic heater 171 provides the following effect.

That is, in the case of using the rubber hose 50 shown in FIG. 4, the inner hole 17i of the ceramic heater 171 and the second internal space 50i of the rubber hose 50 communicate with each other, so that the volume of the inner hole 17i substantially increases by an amount corresponding to the second internal space 50i of the rubber hose 50.

Then, expansion and contraction of the air in the inner hole 17i shown in FIG. 5 become greater as compared to the case of not using a separate member (rubber hose 50). Thus, the amount of the liquid W introduced into the inner hole 17i through expansion and contraction of the air in the inner hole 17i described above can be increased, whereby cooling of the ceramic heater 171 via the inner hole 17i can be further promoted.

In view of the above, if an inside volume V2 of the second internal space 50i of the rubber hose 50 is not less than two times an inside volume V1 of the inner hole 17i of the ceramic heater 171, the apparent volume of the inner hole 17i becomes three times or more, thus having an advantage that cooling can be assuredly promoted.

As shown in FIG. 4 and FIG. 6, in this example, the closing portion 60, 62 is located on the base-end side relative to the heat generation portion 17a.

Thus, as compared to a case where the closing portion 60, 62 is located on the distal-end side relative to the heat generation portion 17a, the volume of the inner hole 17i can be increased, so that the amount of the liquid W introduced into the inner hole 17i through expansion and contraction of the air in the inner hole 17i described above can be increased.

If the watt density is 100 W/cm² when AC voltage of 100 V is applied to the ceramic heater 171, the heating temperature of the heater readily becomes a higher temperature. Therefore, the present invention can be effectively applied.

In a cross-section of the ceramic heater 171 along the radial direction perpendicular to the front-rear direction L, if the maximum width of an inner wall surface forming the inner hole 17i is 0.5 to 5.0 mm, the liquid W hardly enters the inner hole 17i. Therefore, the present invention is effectively applied.

Here, the maximum width of the inner wall surface refers to the maximum distance between inner wall surface parts forming the inner hole in the cross-section.

Specifically, considering also a case where the shape of the inner hole is not a circle, as shown in FIG. 7, the maximum width is defined as a diameter D of a circle C having the smallest diameter among circles that contain therein the entire outer periphery of the inner hole 17i on the cross-section.

Regarding the cross-section, as shown in FIG. 4, in a case where the closing portion (resin 60, etc.) is not present in the ceramic heater 171, three cross-sections S1, S2, S3 are defined at positions where the ceramic heater 171 is equally divided into four parts in the front-rear direction L, and the average value of the diameters D in the cross-sections S1, S2, S3 is used as the “maximum width of the inner wall surface”.

On the other hand, in a case where the closing portion is present in the ceramic heater 171, three cross-sections are defined at positions where, of the ceramic heater 171, a region on the distal-end side relative to the closing portion is equally divided into four parts in the front-rear direction L, and as in the above manner, the average value of the diameters D in the three cross-sections is used as the “maximum width of the inner wall surface”.

It should be understood that the present invention is not limited to the above embodiments and incorporates various modifications and equivalents within the idea and the scope of the present invention.

For example, the shapes of the liquid heating device and the ceramic heater are not limited.

The closing portion is not limited to a member (seal material or sealing material) independent of the ceramic heater. For example, in production of the ceramic base 17g, the inner hole 17i may be formed to be closed on the base-end side, so that the closing portion may be integrated with the ceramic heater.

As the closing portion, a seal material (sealing material) such as epoxy resin or glass may be used, for example.

Similarly, also the separate member connected to the base end of the ceramic heater is not limited to such a structure that the closing portion such as a sealing material is provided at the end of the separate member. The inner hole of the separate member may be opened only at one end and may be closed at another end integrally with the separate member.

### Examples

Alumina powder and glass-component powder serving as a sintering aid were crushed and mixed with water by a mill, and then were mixed with a binder, to obtain a clay-like mixture. Using an extruder, the clay-like mixture was extruded from a die with a core placed therein, to produce a tubular ceramic base, which was then cut into a predetermined length and calcined.

Meanwhile, on an alumina green sheet, using a tungsten/molybdenum paste, a heat generation body pattern was formed and further a terminal portion connected to this pattern and leading to a sheet opposite surface was printed and formed.

The printed ceramic green sheet was wrapped around the calcined ceramic base, and these were sintered integrally. An exposed terminal portion of the sintered ceramic heater was plated with Ni, and a lead member made of Ni was brazed and joined thereto by Ag solder, thus obtaining a lead-equipped ceramic heater.

Further, an annular resin flange was fitted to the base-end side of the ceramic heater, and both members were joined by an epoxy adhesive.

This ceramic heater was inserted into an opening of a side wall of a container made of resin from the distal-end side, and a rubber material was interposed between the flange and the side wall, to make airtight sealing. In addition, an epoxy adhesive was applied as a closing portion on the base-end side of the ceramic heater, thus making sealing.

For the above ceramic heaters, the entire lengths were set at 60 mm, the heat generation portion lengths were set at 30 mm, the inner diameters of the inner holes were set at 0.7 mm, and the room-temperature resistance values were set at 6Ω and 9Ω, and liquid heating devices provided with these ceramic heaters were produced as Examples 1 and 2.

As Comparative example 1, the same ceramic heaters as in each Example were used, the opening at the distal end of each ceramic heater (ceramic base) was sealed by an alumina heatproof adhesive, and the ceramic heaters were attached to a container, thus producing a liquid heating device.

As Comparative example 2, ceramic heaters that were the same as in each Example except that the ceramic bases have no holes (were solid), were produced, and the ceramic heaters were attached to a container, thus producing a liquid heating device.

While water having a temperature of 5° C. flowed at a flow rate of 450 cc/min through the inlet of the liquid heating device in each of Examples and Comparative examples, application voltage per heater was controlled so that the temperature of warm water flowing out from the outlet became 35° C., and a cycle in which heater voltage application was performed for 15 seconds and the application was stopped for 15 seconds, was repeated 30 times, thus conducting a consecutive water passing test.

In Examples 1 and 2, warm water was produced without any problem during the consecutive water passing test, and no abnormality was found in the ceramic heaters after the test.

In Comparative examples 1 and 2, the ceramic heaters were cracked with five or less cycles and four or less cycles, respectively, and thus warm water production was stopped.

From the above, it was found that, in Examples in which the inner hole of each ceramic heater was opened on the distal-end side and closed on the base-end side, the air in the inner hole expanded and contracted through heating of the heater and stop of the heating, and the liquid could be easily introduced into the inner hole when the air contracted, whereby the ceramic heater could be cooled via the inner hole.

### DESCRIPTION OF REFERENCE NUMERALS

17a heat generation portion
17i inner hole
17T front-end portion of ceramic heater
17R base-end portion of ceramic heater
50 separate member
50i second internal space
60,62 closing portion
100 container
100i internal space
103 inlet
105 outlet
171,172 ceramic heater
200 liquid heating device
L front-rear direction
m opening
W liquid (water)

1. A liquid heating device comprising:
a container having an internal space, and an inlet and an outlet communicating with the internal space; and
a ceramic heater which extends in a front-rear direction and whose front-end portion is located in the internal space, the ceramic heater having a heat generation portion at the distal-end portion, wherein
in a process in which a liquid is introduced from the inlet and flows through the internal space to the outlet, the liquid is heated by the ceramic heater,
the ceramic heater has an inner hole extending in the front-rear direction and having an opening at a distal end, the inner hole communicating with the internal space, and
the inner hole is closed by a closing portion on a base-end side.

2. The liquid heating device according to claim 1, wherein
the closing portion is located on a base-end side relative to the heat generation portion.

3. The liquid heating device according to claim 1, wherein
the closing portion is provided to a member separate from the ceramic heater, the separate member being connected to a base end of the ceramic heater so that, inside the separate member, a second internal space is formed as a part of the inner hole.

4. The liquid heating device according to claim 1, wherein
a watt density is 100 W/cm² when AC voltage of 100 V is applied to the ceramic heater.

5. The liquid heating device according to claim 1, wherein
in a cross-section of the ceramic heater along a radial direction perpendicular to the front-rear direction,
a maximum width of an inner wall surface forming the inner hole is 0.5 to 5.0 mm.
